(19) United States
(12) Patent Application Publication
(10) Pub. No.: US 2009/0119612 A1
(43) Pub. Date: May 7, 2009

(54) SYSTEM AND METHOD FOR RELATED INFORMATION SEARCH AND PRESENTATION FROM USER INTERFACE CONTENT

(76) Inventor: ROBERT A. WHITE, Needham, MA (US)

Correspondence Address: HOLLAND & KNIGHT LLP, 10 ST. JAMES AVENUE, 11th Floor, BOSTON, MA, 02116-3889, US

(21) Appl. No.: 12/247,274

(22) Filed: Oct. 8, 2008

Related U.S. Application Data
(63) Continuation of application No. 11/680,645, filed on Mar. 1, 2007.

(51) Int. Cl. G06F 3/048; G06F 17/30

(52) U.S. Cl. 715/781; 707/3; 707/E17.014

(57) ABSTRACT

A method of providing information related to content presented within a first window, the method comprising extracting primary information from the content in response to activation of an interactive mechanism, the primary information including entities mentioned in the content, obtaining related information from content sources based on the primary information, wherein related information includes connection paths between a user and the entities, and generating a summary page including items of primary information in association with the related information. At least some of the items from the primary information and items from the related information can be provided as user selectable links to corresponding detailed information.

### CROSS REFERENCES TO RELATED APPLICATIONS

This application claims the benefit of priority under 35 U.S.C. §119(e) from co-pending, commonly owned U.S. provisional patent application Ser. No. 60/882,048, entitled SYSTEM AND METHOD FOR RELATED INFORMATION SEARCH AND PRESENTATION FROM USER INTERFACE CONTENT, filed Dec. 27, 2006.

### FIELD OF INTEREST

The present inventive concepts relate to the field of information searching, gathering and presenting, particularly with respect to networked computer systems and electronic information presented therein.

### BACKGROUND

It takes a lot of time to research entities, such as companies, people and events that are mentioned on Web pages. This includes, for example, news articles, company management team pages, 10-k's, blogs and any other unstructured content delivered into a Web browser.

A salesperson, for example, might want to know more about an executive mentioned in a news article, and what other articles the executive has been mentioned in. Does the salesperson have any connections to the executive through his or her network? What is the executive's work history? What schools did the executive attend? What organizations does the executive belong to? Answering any one of these questions can help salespeople, recruiters, HR specialists and others to learn more and connect to the individual. This information is at best hard to find and at worst unavailable.

A common approach to finding such information is through the Internet and Worldwide Web. But there is really no way to analyze an entire Web page at once in real time. People read Web pages. They get interested in a company, person or topic and they might go off to research the topic. In some cases the Web site will link the person or company to more detailed information for that individual entity. In many cases, the user will use a search engine to search and review resulting Web pages that may provide more information. Users will also access free or subscription services to search for more information on an entity.

In each case, the user is forced to do the work and search for the information on the Internet and the Worldwide Web. The user typically has to research each person, company and topic, one at a time. This can take a substantial amount of time and effort. The majority of people who would receive benefit from this research never get it because it is simply too difficult or time consuming to do the work and find the relevant information.

### SUMMARY OF INVENTION

According to various aspects of the invention, provided is a generation system and method configured to quickly process Web page content upon activation of an interactive mechanism provided within or in relation to a browser. The processing includes analysis of the content and extraction of primary information, as well as searching, gathering, and presenting of related information. The related information can include connection information associated with the primary information and/or information otherwise available that references or is about the primary information. The presentation of the related information can include generation and display of a summary page that shows at least a portion of the extracted primary information in association with the related information. The summary page can be displayed in a second window or can be presented within the first window and can include user selectable links that provide further information about the primary information, related information, or a combination thereof.

According to one aspect of the invention, provided is a method of processing content presented within a first window. The method comprises extracting primary information from the content in response to activation of an interactive mechanism. The primary information includes entities mentioned in the content. The method also includes obtaining related information from content sources based on the primary information, wherein the related information includes connection paths between a user and the entities. And the method also includes generating a summary page including the primary information in association with the related information.

The first window can be a first browser window.

The interactive mechanism can be a button integrated into the first browser window.

Selecting the button can automatically cause searching for the related information from the content sources and the generating of the summary page.

Obtaining the related information from the content sources can include searching the Internet for Web sites, systems and databases for the related information.

Obtaining a connection path between the user and an entity can include searching a contact database of the user.

Each of the connection paths can be defined by information that maps the user to one of the entities mentioned in the content, and which can include a set of intermediate entities not mentioned in the content.

The method can further comprise generating a second window and displaying the summary page in the second window.

The primary information can further include events included in the content and the entities can include people and companies; the related information can include one or more people, companies, entities, events, triggers, and relationships.

Generating the summary page can include listing the events and entities that comprise the primary information.

Generating the summary page can further include, for each entity from the primary information that is a person, listing the name of the person, a title of the person, if available, and a number of connections between the user and the person.

Generating the summary page can further include, for each entity from the primary information that is a company, listing a name of the company, a number of news items related to the company, and a number of connections between the user and the company, company directors, board members, executives and other employees, or a combination thereof.

Generating the summary page can further include, for each entity from the primary information, listing the events related to the entity for at least one period of time.

Generating the summary page can further include providing targeted advertising related to the primary information, the related information, the user, or a combination thereof.

The first window can include a page having a plurality of segments, and the method can further comprise determining the content by parsing the page to determine at least one segment from the plurality of segments that includes the content.

The method can further comprise providing at least some of the primary information and the related information as user selectable links to corresponding detailed information.

The first window can include a Web page of a content provider and the interactive mechanism can be a toolbar button associated with the content provider, wherein actuation of the toolbar button causes indicia of the content provider and ads related to the content to be presented in the first window, the summary page, or both.

In accordance with another aspect of the invention, provided is a method of processing content presented within a first browser window in response to activation of a graphical mechanism. The method comprises extracting primary information from the content, the primary information comprising entities, including people and companies, and events mentioned in the content. The method also includes obtaining related information from content sources based on the primary information, wherein the related information includes information forming connection paths between a user and the entities and the events and includes information that references the entities and the events. And the method also includes generating a summary page including a list of the events and the entities, including a list of the people and a list of the companies, and the related information.

Obtaining related information from content sources can include searching the Internet for Web sites, systems and databases for the related information.

Obtaining a connection path between the user and an entity can include searching a contact database of the user.

Each of the connection paths can be defined by information that maps the user to one of the entities mentioned in the content, and which can include a set of intermediate entities not mentioned in the content.

The method can further comprise generating a second window and displaying the summary page in the second window.

Generating the summary page can include, for each entity from the primary information that is a person, listing a name of the person, a title of the person, if available, and a number of connections between the user and the person.

Generating the summary page can include, for each entity from the primary information that is a company, listing a name of the company, a number of news items related to the company, and a number of connections between the user and the company, company directors, board members, executives and other employees, or a combination thereof.

Generating the summary page can include, for each entity from the primary information, listing the events related to the entity for at least one period of time.

Generating the summary page can further include providing targeted advertising related to the primary information, the related information, the user, or a combination thereof.

The first window can include a page having a plurality of segments, and the method can further comprise determining the content by parsing the page to determine at least one segment from the plurality of segments that includes the content.

The method can further comprise providing at least some of the primary information and the related information as user selectable links to corresponding detailed information.

The first browser window can include a Web page of a content provider and the graphical mechanism can be a toolbar button associated with the content provider, where actuation of the toolbar button causes indicia of the content provider and ads related to the content to be presented in the first window, the summary page, or both.

In accordance with another aspect of the invention, provided is a system configured to process content presented within a first browser window. The system comprises a content processor configured to extract primary information from the content in response to activation of a graphical mechanism. The primary information comprises entities, including people and companies, and events mentioned in the content. The system also includes a connection module configured to obtain related information from content sources based on the primary information, wherein the related information includes information forming connection paths between a user and the entities and events and includes information that references the entities and the events. And the system also includes a summary page generator configured to generate a summary page including a list of the events and the entities, including a list of the people and a list of the companies, and the related information.

The connection module can be further configured to search the Internet for Web sites, systems and databases for the related information.

The connection module can be configured to search a contact database of the user to obtain a connection path between the user and an entity.

The connection module can be configured to define each of the connection paths as information that maps the user to one of the entities mentioned in the content, and which can include a set of intermediate entities not mentioned in the content.

The summary page generator can be further configured to generate a second window and to display the summary page in the second window.

The summary page generator can be further configured to generate the summary page to include, for each entity from the primary information that is a person, a list including a name of the person, a title of the person, if available, and a number of connections between the user and the person.

The summary page generator can be further configured to generate the summary page to include, for each entity from the primary information that is a company, a list including a name of the company, a number of news items related to the company, and a number of connections between the user and the company, company directors, board members, executives and other employees, or a combination thereof.

The summary page generator can be further configured to generate the summary page to include, for each entity from the primary information, a list of the events related to the entity for at least one period of time.

The summary page generator can be further configured to provide at least some of the items from the primary information and items from the related information as user selectable links to corresponding detailed information.

The first browser window can include a page having a plurality of segments and the content processor can be further configured to determine the content by parsing the page to determine at least one segment from the plurality of segments that includes the content.

The system can further comprise an ad module configured to provide targeted advertising related to the primary information, the related information, or a combination thereof.

The first browser window can include a Web page of a content provider and the graphical mechanism can be a toolbar button associated with the content provider, wherein actuation of the toolbar button causes the ad module to present indicia of the content provider and ads related to the content in the first window, the summary page, or both.

In accordance with another aspect of the present invention, provided is a computer program product stored in a computer readable medium and configured to be executed by at least one processor to perform a method of processing content presented within a first browser window. The method includes extracting primary information from the content in response to activation of a graphical mechanism. The primary information comprises entities, including people and companies, and events mentioned in the content. The method also includes obtaining related information from content sources based on the primary information, wherein the related information includes information forming connection paths between a user and the entities and events and includes information that references the entities and the events. And the method includes generating a summary page including a list of the events and the entities, including a list of the people and a list of the companies, and the related information.

Obtaining the related information from the content sources can include searching the Internet for Web sites, systems and databases for the related information.

Obtaining a connection path between the user and an entity can include searching a contact database of the user.

Each of the connection paths can be defined by information that maps the user to one of the entities mentioned in the content, and which can include a set of intermediate entities not mentioned in the content.

The method can further comprise providing at least some of the primary information and the related information as user selectable links to corresponding detailed information.

Generating the summary page can further include providing targeted advertising related to the primary information, the related information, the user, or a combination thereof.

The first browser window can include a Web page of a content provider and the graphical mechanism can be a toolbar button associated with the content provider, where actuation of the toolbar button causes indicia of the content provider and ads related to the content to be presented in the first window, the summary page, or both.

### BRIEF DESCRIPTION OF THE DRAWINGS

The drawing figures depict preferred embodiments by way of example, not by way of limitation. In the figures, like reference numerals refer to the same or similar elements.

FIG. 1A is a block diagram showing an embodiment of a system that can be used for processing a Web page and returning related information, in accordance with aspects of the present invention.

FIG. 1B is a method of generating and presenting a summary page from an original Web page, in accordance with aspects of the present invention.

FIG. 2A is an embodiment of a processing method performed between a client and a server that can be implemented by the devices of FIG. 1A, in accordance with the method of FIG. 1B.

FIG. 2B is an embodiment of a browser window layout in accordance with aspects of the present invention.

FIG. 3A is an embodiment of a browser window having a mechanism for launching summary page generation functionality in accordance with aspects of the present invention.

FIG. 3B is an embodiment of a registration screen that can be used by a user to register with the system of FIG. 1, as an example.

FIG. 3C is an embodiment of a screen summary page displayed in a second window, generated from the screen of FIG. 3A.

FIGS. 4-7A are embodiments of summary pages that can be generated from different types of Web sites and content sources.

FIG. 7B is an embodiment of a screen that can be generated by “drilling-down” on a link in a summary page.

### DETAILED DESCRIPTION OF PREFERRED EMBODIMENT

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements may be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

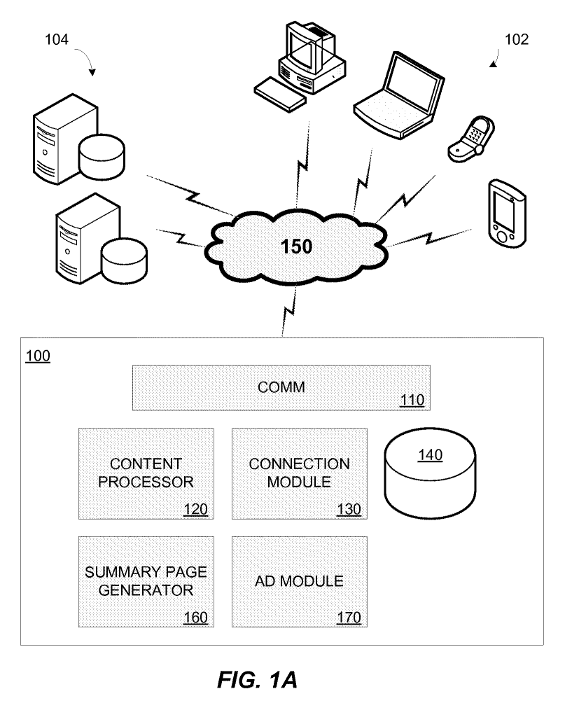

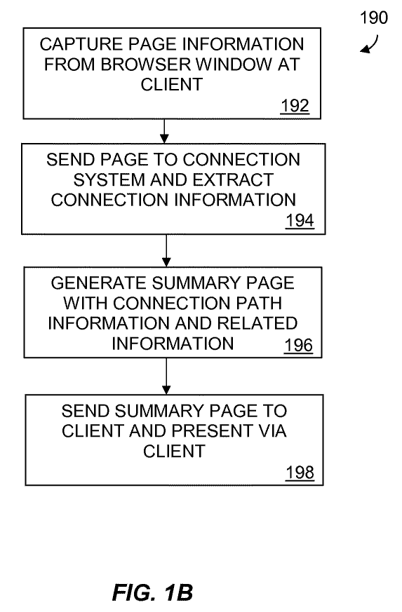

FIG. 1A is a block diagram showing an embodiment of a system and application modules 100 (collectively, the “generation system 100” or “system 100”), useful for analyzing content of a page displayed in a browser window to generate a summary page that includes information related to the original content, as related information. The related information can include information about the entities mentioned in the original content and information showing connection paths (or connections) from a user to those entities. System 100 can be used for processing a Web page (or the like) presented on any of a variety of user devices 102 and returning the related information. In this embodiment, the system 100 can be accessed by a variety of types of user devices 102 via one or more networks, collectively depicted as a network or network cloud 150.

Network 150 can comprise one or more of the Internet, World Wide Web, a local area network, wide area network, virtual network, cellular network, satellite network, cable network, and so on, whether wired, wireless, or some combination thereof. User devices 102 can include one or more of a personal computer (e.g., desktop or laptop computer), cellular telephone, personal digital assistance, or other network enabled device.

In this exemplary embodiment, system 100 can comprise a database 140 of information that includes information used to form connection paths between people and entities (e.g., companies). A connection path (or connections) is, generally speaking, a relationship between two entities (e.g., people). One entity can define a starting point or node in the connection path and the other entity can define an ending point or node, referred to as a target, in the connection path. There can be intermediate connection points or nodes between the starting and the ending points that form part of the connection path. Each point or node is defined by electronic information available from one or more databases or systems, such as database 140. As will be appreciated by those skilled in the art, database 140 can comprise any type or combination of databases systems and/or storage media, such as one or more of a hard drive, optical drive, disk, tape, RAM, ROM, and so forth.

A set of functional modules are included to interact with user devices 102, database 140, and, if necessary, third party databases, content sources, and/or service providers 104 (collectively, “third party systems”). The functional modules of system 100 can include a communications module 110 configured to interact with the user devices 102 and third party systems 104 via network 150, using known communication hardware, software and protocols.

As an example, the user devices 102 can be configured with a client-side program that captures a Web page from a browser window and communicates it to system 100 via network 150, and further processes or assists in processing information received from system 100 via network 150.

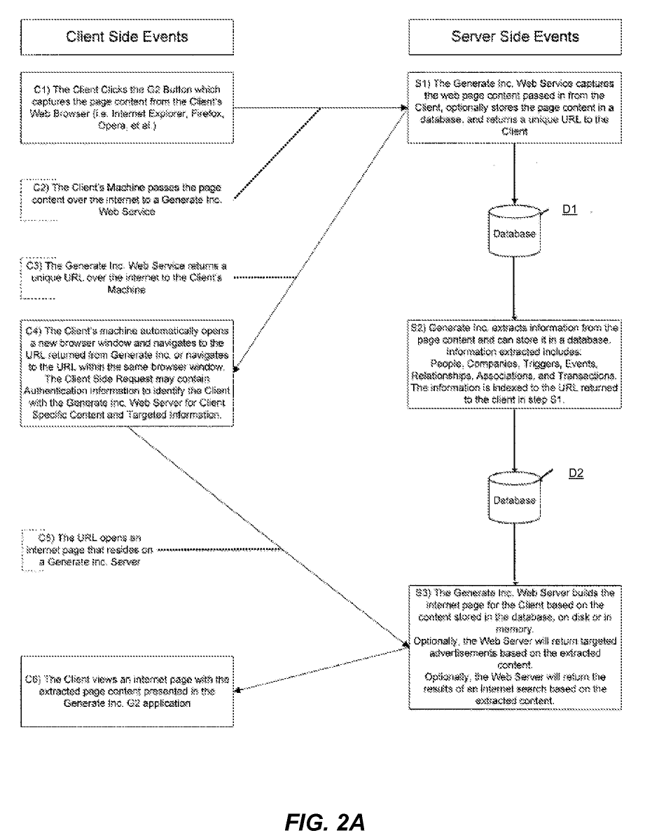

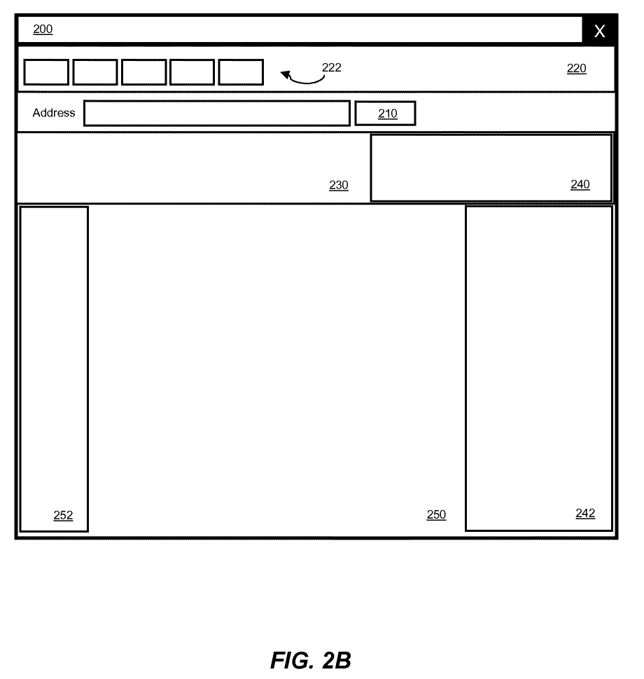

System 100 can include a content processor module 120 configured to extract information from, for example, a Web page being viewed by a user (not shown) operating a user device 102, and referred to generally as content or original Web page content. The information extracted from the content is referred to as primary information and includes, in this embodiment, people, entities (e.g., companies) and events mentioned in the content, e.g., an article being viewed in a browser. Given that a browser window can include a plurality of segments (or panes) within which information can be presented, the content processor module 120 can further be configured to determine at least one specific segment from which the primary information is to be extracted, see for example FIG. 2B. Such determination can be made based on HTML tags of a Web page, for example.

System 100 also includes a connection module 130 that finds information related to the primary information from database 140 and, optionally, third party systems 104. The related information can include connections between the user and the people and entities included in the primary information and/or information otherwise available that references or is related to the primary information.

System 100 further includes a summary page generator 160 configured to generate a summary page having items of primary information and related information, which can include selectable active links.

System 100 can optionally include an advertising (or ad) module 170 configured to serve ads based on one or more of the primary information, related information, and/or the user.

It should be understood, that while the illustrative embodiment indicates that system 100 performs Internet and Web searching and returns the summary page, client side software could be configured to accomplish some of that same functions, e.g., in conjunction with system 100. It should also be understood that system 100 could be a standalone system, or it could be part of an enterprises system of a company or other entity. It should also be understood, that a combination of client, enterprise and standalone functionality could be used to provide the functions disclosed herein.

FIG. 1B provides a flowchart depicting a method 190 for generating a summary page having connection path information from a Web page, in accordance with aspects of the present invention. As a first step, upon activation of the appropriate mechanism (e.g., a toolbar button, see button 210 in FIG. 2B) a program is launched that captures Web page information from the page displayed in the browser window. In step 194, the captured page information is sent to system 100, where connection information is extracted from the page, such as names of people and companies mentioned in the original content. In step 196 a summary page is generated that includes connections from a user to the people and/or companies extracted. In step 198 the summary page is sent to the client device for presentation.

FIG. 2A is an embodiment of a processing method that can be implemented between a client-side device or system (i.e., user device 102) and a server-side device or system (i.e., system 100) to accomplish the above described functions. The method of FIG. 2A is one possible detailed embodiment of the method of FIG. 1B. In this embodiment, an interactive mechanism, such as a button, is included in the browser of the user device, wherein the client-side functionality is associated with the button, and launched upon actuation of the button.

FIG. 2B provides an embodiment of a browser window 200 having a button 210 configured to launch the client-side functionality. The window 200 also has a toolbar 220 that includes other typical browser buttons 222 known in the art, such as those used for navigating among Web pages, refreshing a Web page, and returning to a home page. The page displayed in window 200 can include header information in a segment 230 used to identify the Web site. The page 200 can also include various segments for ads, such as segment 240 and 242. The primary content is provided in segment 250, and page navigation tabs or menus can be provided in segment 252, as sidebar content.

Returning to FIG. 2A, in step C1, on the client side, a user clicks the button 210 associated or integral with the browser window 200 of the user device 102 (as a first window), which launches the client-side functionality to initiate dynamic Web page analysis of the page displayed in the first window 200. The dynamic Web page analysis inspects the Web page, e.g., inspect the Web page HTML, to extract or capture some or all of the contents of a Web page displayed in the browser window 200. If the Web browser window 200 includes a plurality of segments within which information is presented, this step can further comprise determining at least one specific segment from which the primary information is to be extracted, such as segment 250. For example, information in advertising segments 240 and 242 can be ignored.

In step C2, the client device 102 transfers the captured page information to the server system 100, via network 150.

In step S1, on the server side, the captured page information can optionally be stored in a database D1, which can form part of database 140 in FIG. 1A. The content processor 120 of system 100 can be configured to generate and return a unique URL to the client device 102, also indicated by step C3 on the client-side device.

In step S2, on the server side, the content processor 120 extracts primary information from the captured page information, which can be stored in a database D2. Database D2 can also form part of database 140 of FIG. 1A. In this embodiment, the extracted primary information includes information identifying people, entities (e.g., companies) and events captured from the original Web page content in segment 250 of Web page 200. The extracted information can also include triggers, relationships, associations, and transactions captured from the original Web page. The information is indexed to the URL sent to the client device 102.

In accordance with the illustrative embodiment, a trigger is an event that indicates that a prospect or customer, in a sales context, might be receptive to a call. In this context, the idea is to identify the customers (or other people) at the earliest point in the buying cycle. System 100 can be used to scan thousands of news articles, blogs, market reports, etc. per day trying to identify these events. This number could be scaled up or down in various embodiments. These events can include management changes, new investments, lawsuits, site openings and others. For example, if a company leases out commercial space it will most likely need phone systems, office furniture, insurance, etc. The trigger can let a sales person know that a new lease has been signed.

In steps C4 and C5, on the client side, the user device 102 opens a second browser window and navigates to the URL in the second window. The client side issues a request to system 100 for a summary page at the URL, which is presented in the second browser window. Alternatively, the summary page can be presented in the first browser window, and no second window need be opened. In either case, the summary page includes items of primary information and items of related information.

The request from the user device 102 can include user authentication information to identify the client and/or user with server system 100, e.g., for obtaining user specific content and targeted information.

In step S3, on the server side, the summary page generator 160 builds the summary page as a Web page. Information for generating the summary page can be obtained from or based on the information stored in the database 140 from step D2, which can include the primary information extracted from the original Web page and the related information obtained in relation to the primary information. The system 100 can also include items of information obtained from third party systems 104, e.g., in a Web-based or Internet search.

Optionally, advertising or targeted advertising can be included in conjunction with the summary page, and served by ad module 170. For example, as discussed with respect to FIG. 1A, the system 100 can include an advertising module 170 configured to serve up advertisements based on the entities (e.g., companies), people and events mentioned in an article of the original Web page, or the information in the summary page, or information about the user.

In step C6, on the client side, the returned summary page is displayed in the second window (if one was opened), within the first window, or a combination of both. Information within the summary page is presented for viewing and interaction by a user of the user device 102. Items of primary information and items of related information can be displayed as active links that allow the user to selectively “drill down” on such items to gain further information or migrate to, for example, a different Web page, search engine, system 100, and/or another site.

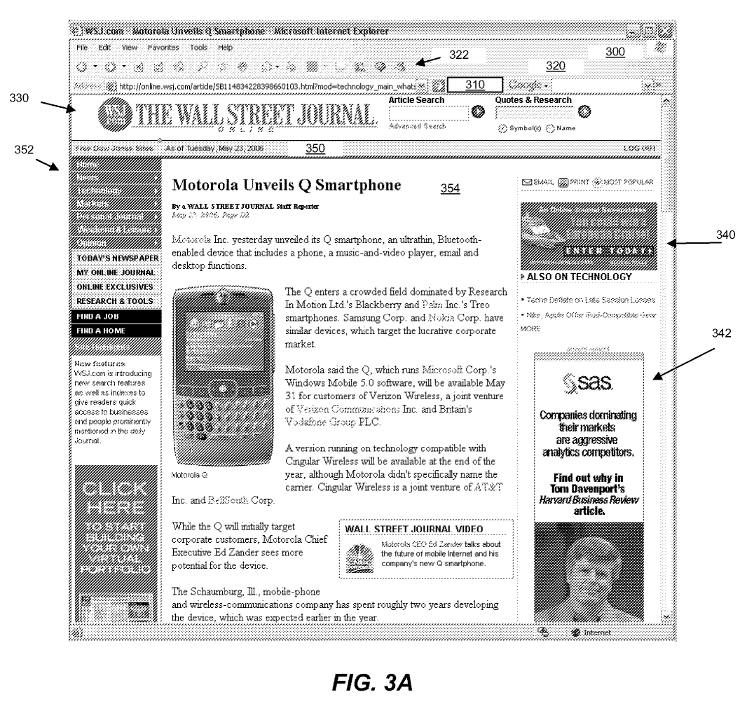

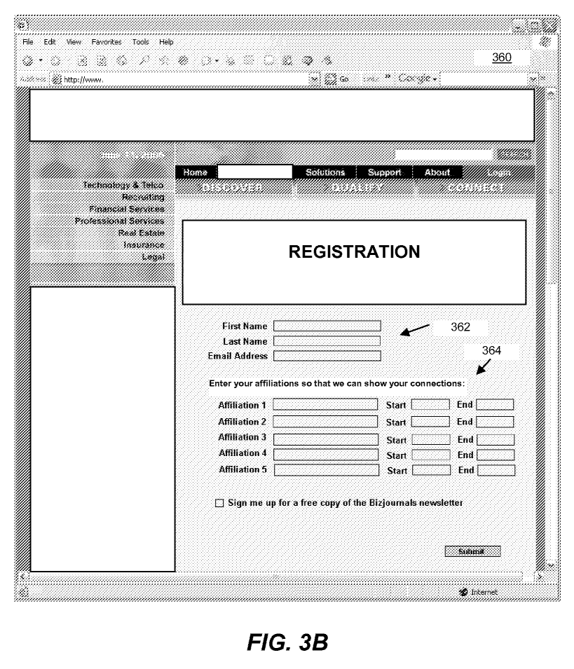

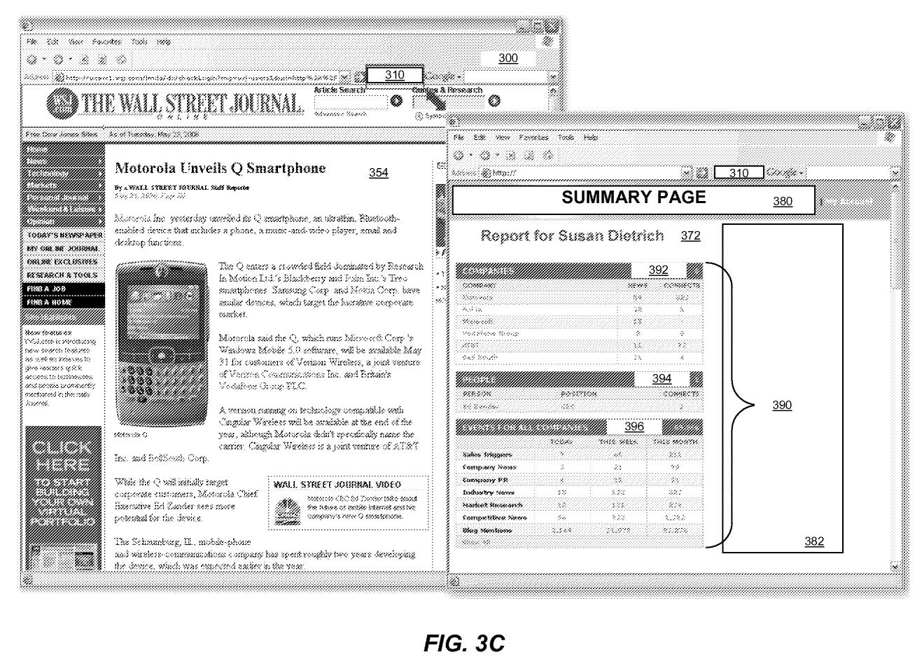

FIG. 3A shows an example of a browser window 300 that can be displayed on a user device 102. In this example, the original Web page is a Web page from the Web site of the Wall Street Journal, as indicated in header segment 330 of window 300. Advertising information is provided in segments 340 and 342 and the original Web page content 354 from which the primary information is captured is displayed in a main segment 350. A segment 352 includes sidebar content, e.g., user selectable tabs for navigation to other pages.

The browser window 300 also includes a summary page generation button 310, corresponding to button 210 in FIG. 2B, as an illustrative embodiment of an interactive mechanism that can be used to initiate summary page generation from the content of the browser window 300, including the search and aggregation of information related to the primary information from system 100 and/or other third party sources 104. Button 310 has been added to the toolbar area 320 of the browser window 300. In other embodiments, the user mechanism could additionally or alternatively be provided in other manners associated with browser 300, e.g., in a menu or as a floating icon or button.

Button 310 can be implemented as a plug-in to a typical browser program installed on a user device 102, such as Internet Explorer™ (Microsoft Corporation), Netscape Navigator™ (Netscape Communications Corporation), and the like. As an example, a user can access system 100 via the Web and download an executable program that, once executed on the user's device, installs the plug-in. This manner of downloading and installing programs is known in the art, as are application program interfaces (APIs) for a variety of browsers that enable the addition of plug-ins.

System 100 can, therefore, be configured to generate and a download page that contains text describing the functionality of button 310 and instructions for downloading and installing button 310. As an example, the text description on the download page rendered by system 100 can read something like:
Use the toolbar button to analyze any Web page for information on the people, companies and events mentioned on the page. Simply click the Download Now icon to download and install the button.

The download of button 310 can be implemented as a self-extracting file that contains all of the files required for installing the toolbar button. When the user clicks the Download Now option the user can be presented with a dialog box that requests its username and password. The user can enter their credentials and click “Continue” or can click “Cancel.” After entering its user credentials a standard file Run or Save dialog box can be displayed. The user can select “Run” to download the file and automatically install button 310. The user can click “Save” to download and save the install package, and run it at a later time. The user can click “Cancel” to return to the download page.

The installation process can run automatically after download or when the user executes the downloaded file. The install process can complete without any required user interaction. And button 310 can display in the browser immediately after installation, without the user taking any other action.

In various embodiments, the download could be made available on a separate server. As a result, users could download and install the button 310 from such server, without going to system 100. For example, a company (or other entity) could make the download available via their corporate network. In other embodiments the program for installing button 310 could be provided in any other storage media, such as by e-mail or on a CD ROM.

User credentials can be stored on the client, e.g., in a “cookie.” In such a case, the user would not have to type credentials to run the functions associated with button 310. Rather, only a single click of button 310 would be required to execute the above process. Otherwise, the user could enter its credentials for a new session with system 100. Generally, storing user credentials on the client device to expedite login or access to a remote system in known, so not disclosed in detail herein.

In some embodiments, button 310 can include a drop down menu, where a list of options can be displayed in association (e.g., below) the button. The menu contain can one or more of the following user selectable commands:
“Home Page”—Navigates to the home page of system 100.
“Options”—The options menu selection displays a dialog box that allows the user to change the credentials that the button is using or to specify parameters for how the process should be run.
“Help”—The help option displays a sub-menu that includes: a link to a help page on the system 100. The help page can describe the toolbar and its use.
“Uninstall”—Selecting uninstall prompts the user with a dialog that reads “Uninstall will remove the toolbar and all associated files.” The user can click Continue or Cancel.
“About Toolbar”—The about option displays a dialog box with the version number of the toolbar.

The options dialog can contain, for example, username and password fields. The username can be read, the password can be displayed as non-text characters, e.g., asterisks. The user can change the username and password and save them for future use.

The options page can contain a “Forgot password” link. This link can navigate the user to system 100 to allow the user to request a new password or to get hints relating to the existing passwords.

The options page can contain a selection that specifies if the user wants system 100 to try to limit the page analysis to the main segment 350 and content of the Web page (e.g., an article, but not advertisements). This setting is titled “Limit page analysis to content only,” in the preferred embodiment.

In various embodiments, registration with system 100 may be required to use the functionality associated with button 310. This may be particularly important for establishing an identity of the user for generating connection paths between the user and other entities. In such a case, the installation of button 310 can include initiation of a registration session with system 100. Otherwise, a registration session could be initiated upon activation of button 310, e.g., at first use of button 310. FIG. 3B provides an embodiment of a registration window 360 that could be opened upon actuation of button 310. Window 360, in this embodiment, is generated by system 100 and includes a set of text entry fields 362 for user input of its name and e-mail address. A second set of fields 364 solicits input of connection information for the registering user. That is, the information input in fields 364 can be used to determine connection paths.

In such cases, system 100 can include a user account module (not shown in FIG. 1A) that accomplishes registration, authentication, and account management, and the registration information can be stored in DB 140, for example. In other embodiments various types of known registration processes can be implemented. Account management can include maintaining a set of connections to and from the user in DB 140, for example. After registration, the user's subsequent access could require a login to system 100. Again, identifying the user can be necessary for determining connection paths to the user. If login is required, actuation of button 310 could open a login window (not shown), rather than a registration window. Loggin can be required to gain access to the summary page generation functionality and information resources available through system 100. In various embodiments, after registration for example, the user's credentials could be automatically saved on the client devices and sent to system 100 using, for example, a cookie loaded on the user's device 102.

In another embodiment, the system 100 could be configured such that, rather than logging in to the system, the system (or client-side software) could access and analyze the user's contact database on user device 102 and determine connection paths therefrom—in real or near-real time. In some embodiments, the system 100 and/or user device 102 could be configured to implement both approaches. For example, registered users could be entitled to receive more connection path information than non-registered users.

In the present illustrative embodiment, selection or activation of button 310 launches certain functionality for analysis and processing of the page being viewed in the browser window 300. When a Web page includes several segments with different information, e.g., advertisements 340, 342, links to other information, sidebar content 352, and the like, the functionality can be configured to distinguish the main segment 350 and its content (e.g., an article) 354 from the other segments, and to process the content 354 from the main segment 350 and to ignore the other information in the other segments. Distinguishing among these types of segments can be done through analysis of the HTML that defines the Web page.

System 100 can be configured to maintain a list of domains and relevant tags that help to describe the article content of a Web page, apart from ancillary content of the page. This can make processing the Web page more efficient, because the user need not request such action and the analysis of the page can be immediately focused on finding the predefined tag. Bizjournals™ (American City Business Journals, Inc.), for example, could add one or more <div> tags to its article pages that would specify the relevant content to be analyzed. System 100 could be configured to analyze only the contents of the page delineated by that tag or tags.

Processing a Web page using button 310 of FIG. 3A can be better appreciated with respect to the illustrative functional modules of FIG. 1A and the window of FIG. 3C. Specifically, in the illustrative embodiment, when a user clicks or selects button 310, at least a portion of the content of the page is captured and transferred to system 100. In this example, the original content 354 is located in main segment 350 of browser window 300, and is captured and transferred to system 100. At system 100 the content processor 120 is configured to reformat the captured content into a universal document (e.g., an XML document). The universal document is processed by an extraction engine, also part of the content processor 120 in this embodiment. Content processor 120 is configured to output a structured document containing information about one or more of the people, entities (e.g., companies), and news/events within the original content 354.

An entity will often be a company, but can be any type of entity, e.g., university or college, organization, treaty members, government entity, special interest group, club, charity, society, association, or the like. An event can be a management change, product announcement, joint venture, merger, or other noteworthy topic that the extraction engine has been configured to look for within the reformatted structured version of the original Web page content. The structured document is formed to include a list of people, entities, and events mentioned in the content.

The connection module 130 includes an import routine configured to match the people and entities in the structured document to people and entities in an existing database 140, which can include contact information for such people and entities and other useful information, as related information. The connection module 130 can also be configured to search the Internet and Web and other third party systems 104 for additional related information, to update the information in database 140, or both.

The connection module 130 can be configured to determine connection paths from a user, e.g., a user identified in the Web browser session, to people (e.g., executives) and entities mentioned in the original Web page content 354. The connection paths can be, for example, based on the work history and a “power network” of the user (e.g., other people that the user knows) and a target person named in content 354, which can also be stored in the system database 140 or on the user device 102. An electronic address book from an application such as Outlook™ (Microsoft Corporation), Lotus Notes™ (Lotus Software, a subsidiary of IBM Corporation), or Palm Pilot™ (Palm, Inc.) can serve as a basis for connection path information. And a resume, a “CV,” employment related records, or publicly available content could serve as a basis for work history information.

The related information, e.g., connection path information and company information, is returned by system 100 to the client device 102 for presentation, using communication module 110. The presentation can take the form of a summary page displayed on the user device 102 in the original first window or in a new second window. For example, the summary page can take the form of a Web page generated by system 100 and returned in a new browser window on user device 102. In some embodiments, the summary page can be provided via an e-mail, e.g., in addition to or as an alternative to, presentation in a first or second browser window. In such a case, the e-mail can include a link to the summary page or the summary page itself. In such cases, the ability to copy another user on the e-mail can be provided.

If the summary page is presented in the original window, rather than generating a new second window, the summary page results can take up only a portion of the window, e.g., leaving all or some of the original content presented. Alternatively, the summary page information could take up the entire first window.

The summary page can include a list of entities, a list of people, and a list of events mentioned in the original Web page content. The list of entities and people can include a number of news stories or other relevant sites on the Worldwide Web that have been indexed for each person or entity, as related information. The lists can also include the number of connection paths from the user to the person or company (i.e. target), again as related information. The returned summary page can also include a list of the events associated with the people and entities mentioned in the original Web page content.

The summary page can be provided in a form that enables the user to “drill down” on an executive, entity, news link, connection path or other pieces of information to retrieve additional information inside the system 100, or elsewhere on the Internet and Web. That is, the items of information in the summary page can include active links to the system's database 140 or other information obtained from searching third party systems 104 on the Internet and Web. Preferably, the entire process will take only a matter seconds, or less. The user will be able to analyze Web page content (e.g., an article) quickly and easily in real-time.

The example of FIGS. 3A and 3B is continued in FIG. 3C, which provides an example of a summary page presented in a second window 370. In this embodiment, a summary page 380 is generated in response to selection of button 310 and returned to user device 102 by the system 100. The user is identified as “Susan Dietrich” in the subtitle “Report for Susan Dietrich” 372. Summary page 380 is generated using the original page content 354 of browser window 300, i.e. the article entitled “Motorola Unveils Q Smartphone.” The summary page 380 includes a segment 382 that can be used for presenting ads using ad module 170 of FIG. 1A.

In this example, summary page 380 includes a set of lists or tables 390 that list various entities (in this case companies), people, and events—i.e., primary information taken from the original content 354 and the related information stored at or otherwise obtained by system 100 for those people and companies included in the primary information. Specifically, the returned summary page 380 in the second window 370 includes a list of COMPANIES 392, PEOPLE 394, and EVENTS 396.

The list of COMPANIES 392 is a list of each company mentioned in article 354, e.g., Motorola, Inc., Nokia Corporation, Microsoft Corporation, Vodafone Group Plc, and so on. A column entitled “NEWS” lists the number of news stories that mention each company. For example, for Motorola, Inc. the count is 54. A column entitled “CONNECTS” lists the number of connections between the user and each company. For example, for Motorola, Inc. the number of connections is 322. The NEWS and CONNECTS information can be found in the original Web page content 354, system 100 or third party systems 104, user device 102, or a combination thereof.

The list entitled PEOPLE 394 is a list of each person mentioned in the original Web page content 354. List 394 includes a column entitled “PERSON” that provides the name of each person listed in content 354 and a column entitle “POSITION” that provides the job title of each person listed, if available. And a column entitled “CONNECTS” indicates the number of connections between the person and the user Susan Dietrich. Here, there is only one entry, Ed Zander. As shown in FIG. 3C, Ed Zander's position is CEO and there are 2 connections between Susan Dietrich and Ed Zander. The POSITION and CONNECTS information can be found in the original Web page content 354, system 100 or third party systems 104, user device 102, or a combination thereof.

The list entitled “EVENTS FOR ALL COMPANIES” 396 is a list of a number of events of a specific type aggregated for each company mentioned in original Web page content 354. In the embodiment of FIG. 3C, the event types are listed as “Sales Triggers,” “Company News,” “Company PR,” “Industry News,” “Market Research,” “Competitive News,” and “Blog Mentions.” In other embodiments, different event types could be defined. In this embodiment, the list of events 396 includes three columns, entitled “TODAY,” “THIS WEEK,” and “THIS MONTH.” For each type of event there is a count given for each time column. In other embodiments, other time designations could be made. And rather than being aggregated, a count could be shown for each company. The EVENTS FOR ALL COMPANIES 396 information can be found in the original Web page content 354, system 100 or third party systems 104, user device 102, or a combination thereof.

To generate the connection path information in the above lists, additional Web searches can be executed based on the contents 354. In other words, the when user clicks button 310, the contents 354 of the browser window 300 can be analyzed and then one or more Web searches based on the information within the contents 354 can be run to gather related information. In each lists, connection path information can include hot links to further information. For example, a company name can be a hot link, selection of which generates a page with information about that company.

As mentioned above, the processing can be limited to only a specific segment of the Web browser window. In this example, processing is limited to content 354 in main segments 350. That is, advertisements, links and other text that are not necessarily related to the content 354 presented in the browser, nor useful for generating a summary page and connection information are ignored. The page presented in browser window 300 is parsed based on tags within the HTML of the page, and only the content 354 is processed through the content processor 120 (and its extraction engine) of system 100.

In ad segment 382 ads can be presented based on the entities (e.g., companies), people, and events mentioned in the original Web page content 354 can be provided. For example, if the user is reading an article or product announcement in the browser window on a new cell phone, then the ad module 170 of system 100 can be configured to serve up an ad for the Motorola Q™ phone.

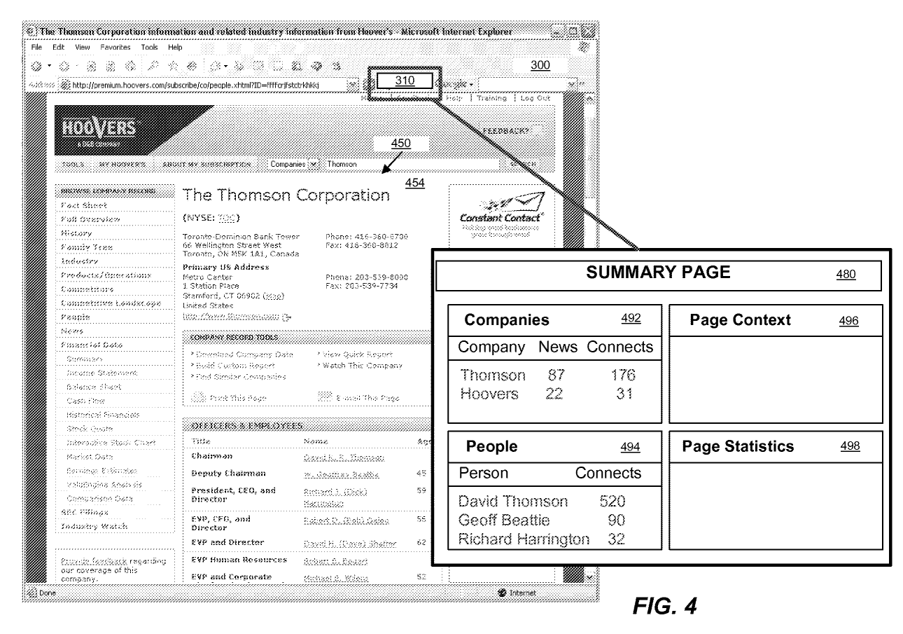

FIGS. 4-7 depict exemplary embodiments of various summary pages that can be generated from a browser window using button 310. As described above, the summary page can be presented in any of a variety of manners, e.g., in a first or second window.

FIG. 4 shows browser window 300 opened up to the Web site of Hoover's, Inc., which has a main segment 450 within which there is displayed a company record for The Thompson Corporation, as original content 454. Actuation of button 310 causes processing of content 454 to generate a summary page 480, in a manner similar to that described above with respect to summary page 380 of FIG. 3C.

The summary page 480 takes a format similar of that of summary page 380. As with summary page 380, summary page 480 includes a list of Companies 492 and that includes a column for the name of each Company mentioned in content 454. There is also a column for News and a column for Connects, similar to those described above. Summary page 480 also includes a list for People 494, which includes a column for the name of each person mentioned in the content 454, also as described above. Optionally, summary page 480 can include a portion entitled Page Context 496 that describes the context in which the events in the summary page occurred, such as a business context, e.g., merger, buyout and so on. The summary page 480 can optionally include a portion entitled Page Statistics 498 that displays information relating to the Web hosting environment, such as statistics about the page itself, e.g., page word count and an identification of the server hosting the Web page.

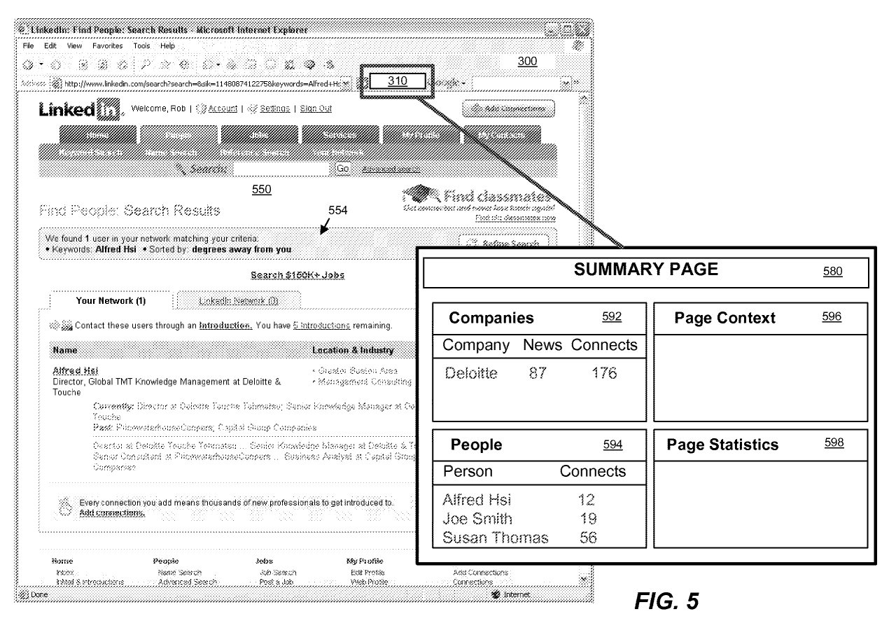

FIG. 5 shows browser window 300 opened to the Web site of LinkedIn Corporation, which has a main segment 550 within which there is displayed a search results, as original content 554. Actuation of button 310 causes processing of content 554 to generate a summary page 580, in a manner similar to that described above with respect to summary page 380 of FIG. 3C. The summary page 580 takes a format similar of that of summary page 480. As with summary page 480, summary page 580 includes lists for Companies 592, People, 594, Page Content 596, and Page Statistics 596.

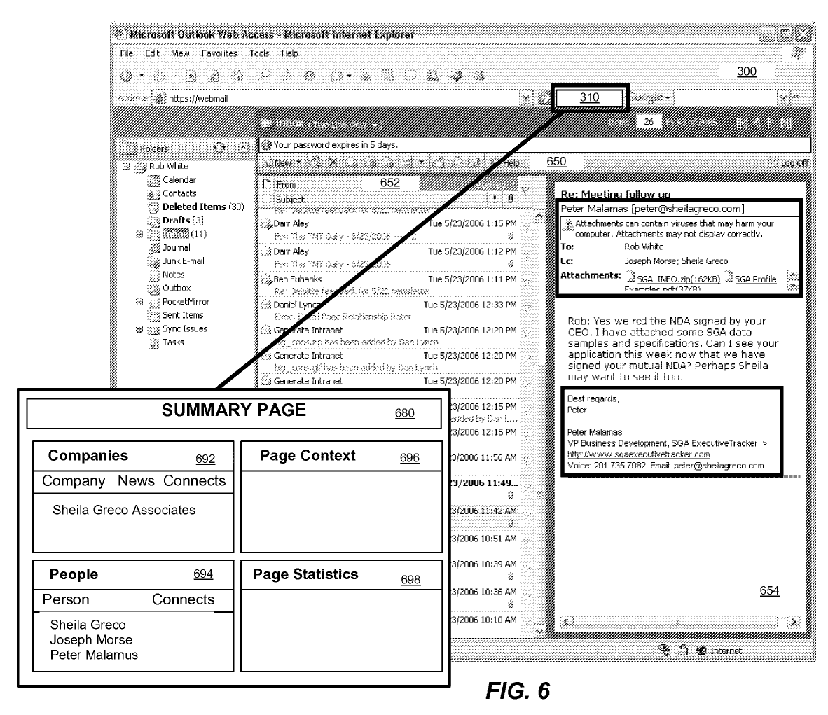

FIG. 6 shows browser window 300 opened to an Outlook™ (Microsoft Corporation) Web-mail interface, which has a main segment 650 within which there is displayed a list of e-mails 652 and a viewing segment or pane with the text of a selected e-mail, as original content 654. Actuation of button 310 causes processing of content 654 to generate a summary page 680, in the manner described above with respect to summary page 380 of FIG. 3C. The summary page 680 takes a format similar of that of summary page 480. As with summary page 480, summary page 680 includes lists for Companies 692, People, 694, Page Content 696, and Page Statistics 696.

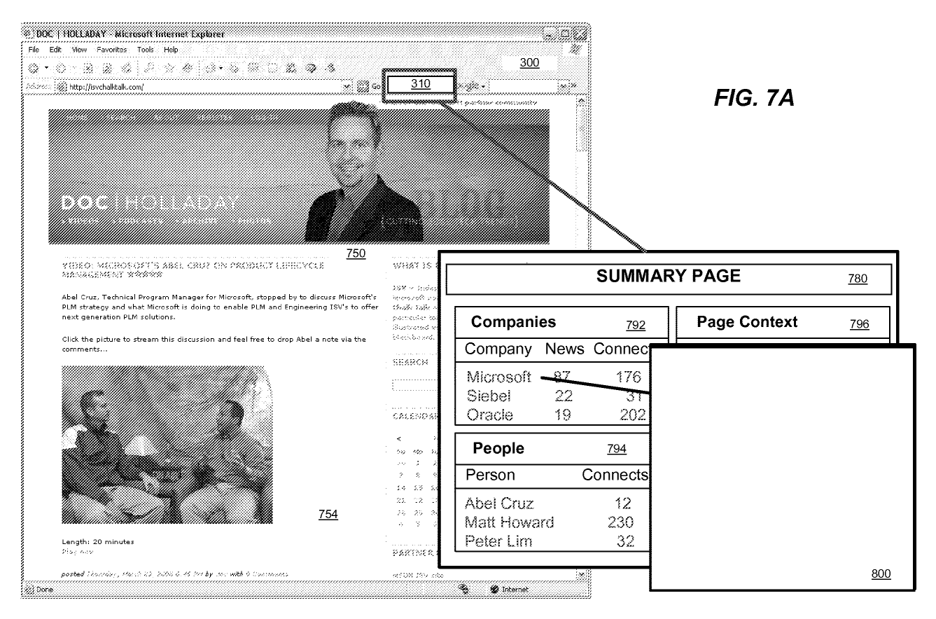

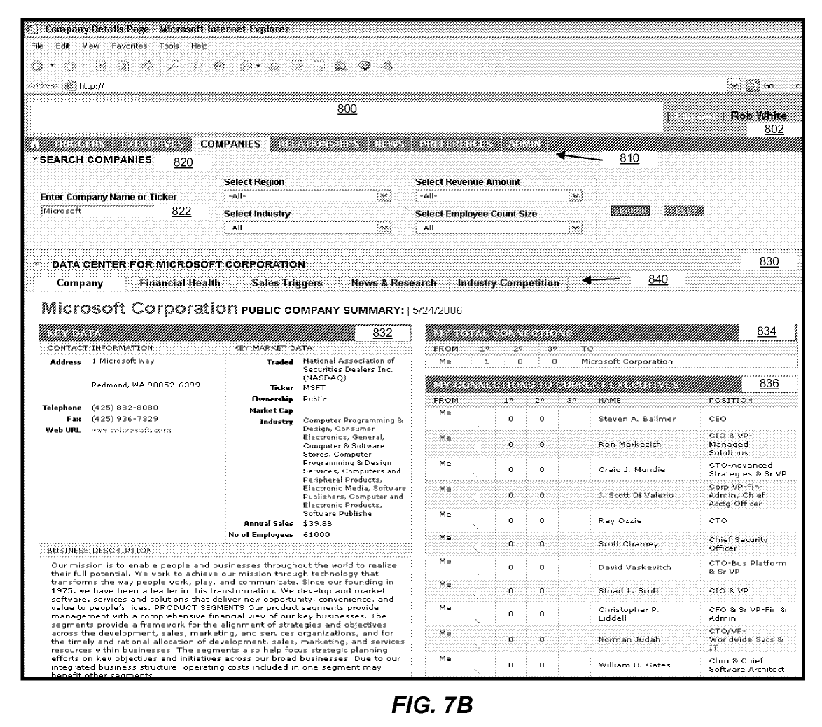

FIG. 7A shows browser window 300 opened to a blog Web site for Doc Holladay, by Microsoft Corporation, which has a main segment 750 within which there is displayed video and text relating to an interview with Microsoft's Abel Cruz, as original content 754. Actuation of button 310 causes processing of content 754 to generate a summary page 780, in a manner similar to that described above with respect to summary page 380 of FIG. 3C. The summary page 780 takes a format similar of that of summary page 480. As with summary page 480, summary page 780 includes lists for Companies 792, People, 794, Page Content 796, and Page Statistics 796 (not shown).

FIGS. 7A and 7B also demonstrate the ability to drill down on information presented in a summary page, here summary page 780. In this example, the companies' names in list 792 are active links to more detailed company and connection information. When, for example, the name Microsoft is selected, window 800 is generated for the presentation of such information.

FIG. 7B demonstrates representative content for window 800 when “Microsoft” is selected. Note that the information is presented relative to a logged in user, Rob White 802. In this example, the screen is presented with a set of tabs 810 that allow viewing of different types of information about the selected company. The tabs 810 include Triggers, Executives, Companies, Relationships, News, Preferences, and Admin. In FIG. 7B the Companies tab is selected, which includes a set of fields 820 for user input of search criteria. The company name Microsoft (for Microsoft Corporation) is defaulted into the Enter Company Name or Ticker field 822—because the screen was generated by selecting Microsoft from the summary screen 780.

Screen 800 also includes a data portion 830, entitled DATA CENTER FOR MICROSOFT CORPORATION, which presents company information and connection information. Data portion 830 also includes a set of tabs 840, entitled Company, Financial Health, Sales Triggers, News & Research, and Industry Competition. Selection of a tab causes data portion 830 to render information related to the subject indicated by the tab label. A section entitled KEY DATA 832 includes general corporate and investor information about Microsoft Corporation. A section entitled MY TOTAL CONNECTIONS 834 provides a list of connections the user 802 has to Microsoft and the degrees of the connection. The degree indicates the number of nodes or connects to a target person (inclusive of the target person). Here 1^{st}, 2^{nd}, and 3^{rd} degrees are accommodated. A section of data portion 830 entitled MY CONNECTION TO CURRENT EXECUTIVES 834 provides a list of the user's connections to those executives, and lists each executive and his or her title—in the case there appear to be none. In this case, system 100 could have obtained a significant amount of the data on Microsoft Corporation in real-time from third party systems, including information made publicly available by Microsoft Corporation.

Screens similar to screen 800 can preferably be generated from any summary screen, when such related information is available on an entity listed in the summary page. Summary page 800 is merely one example.

In various embodiments, a content provider Web site, such as www.wsj.com (by the Wall Street Journal) or www.bizjournals.com (by Bizjournals), can be configured to provide users with an option of downloading button 310, e.g., as a feature of the content provider Web site. Toolbar button 310 can be installed in a toolbar of the Web browser of the user as a branded button that drives traffic to the content provider's Web page from any Web site. For example, the user could be reading a Wall St. Journal article, their favorite blog, or be looking at a company profile in Hoovers. In each case the toolbar button 310 acts as an extension to the current Web page allowing the user to distill the information in the Web page into a clear summary page overview. The user finds itself in a new browser window where the content provider's brand and advertising can be displayed. Advertising can also be displayed in the new window in relation to the content of the page the user is processing. Because button 310 extracts the people, companies, and events from the Web page, the publisher of the original Web page can serve advertising that is related to the page. In other cases the button can be provided as a co-branded toolbar button of the content provider and a company providing the functionality of the button 310.

As an additional service the publisher can register the user and provide user credentials. When the user is logged into system 100, this will provide personalization within the Web browser that shows connection paths from the user to the extracted people and companies. Enabling these connection paths requires system 100 to have access to the user's company and executive affiliations. The user could be provided an interface to enable the user to enter this information, e.g., a Web page served by system 100. Preferably, the interface provides an intuitive mechanism for helping the user to add these affiliations.

The branded toolbar button can differentiate the content provider's Web site offering from other news, research, and list services. The toolbar button provides real-time information and does not require the user to navigate to an information application and login, and takes the next step from simply locating content. Search engines, like Google™, Yahoo™, etc., provide useful ways to locate content, but button 310 and system 100 take the next step to distilling and making sense of it.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

What is claimed is:

1-17. (canceled)

18. A method of processing content presented within a first browser window, the method comprising:
in response to activation of a graphical mechanism: extracting primary information from the content, the primary information comprising entities, including people and companies, and events mentioned in the content;
obtaining related information from content sources based on the primary information, wherein the related information includes information forming connection paths between a user and the entities and the events and includes information that references the entities and the events; and
generating a summary page including a list of the events and the entities, including a list of the people and a list of the companies, and the related information.

19. The method of claim 18, wherein obtaining the related information from the content sources includes searching the Internet for Web sites, systems and databases for the related information.

20. The method of claim 18, wherein obtaining a connection path between the user and an entity includes searching a contact database of the user.

21. The method of claim 18, wherein each of the connection paths is defined by information that maps the user to one of the entities mentioned in the content, and which can include a set of intermediate entities not mentioned in the content.

22. The method of claim 18, further comprising generating a second window and displaying the summary page in the second window.

23. The method of claim 18, wherein generating the summary page includes: for each entity from the primary information that is a person, listing a name of the person, a title of the person, if available, and a number of connections between the user and the person.

24. The method of claim 18, wherein generating the summary page includes: for each entity from the primary information that is a company, listing a name of the company, a number of news items related to the company, and a number of connections between the user and the company, company directors, board members, executives and other employees, or a combination thereof.

25. The method of claim 18, wherein generating the summary page includes: for each entity from the primary information, listing the events related to the entity for at least one period of time.

26. The method of claim 18, wherein generating the summary page further includes providing targeted advertising related to the primary information, the related information, the user, or a combination thereof.

27. The method of claim 18, wherein the first window includes a page having a plurality of segments, and the method further comprises determining the content by parsing the page to determine at least one segment from the plurality of segments that includes the content.

28. The method of claim 18, further comprising providing at least some of the primary information and the related information as user selectable links to corresponding detailed information.

29. The method of claim 18, wherein the first browser window includes a Web page of a content provider and the graphical mechanism is a toolbar button associated with the content provider and actuation of the toolbar button causes indicia of the content provider and ads related to the content to be presented in the first window, the summary page, or both.

30-41. (canceled)

42. A computer program product stored in a computer readable medium and configured to be executed by at least one processor to perform a method of processing content presented within a first browser window, the method comprising:
extracting primary information from the content in response to activation of a graphical mechanism, the primary information comprising entities, including people and companies, and events mentioned in the content;
obtaining related information from content sources based on the primary information, wherein the related information includes information forming connection paths between a user and the entities and events and includes information that references the entities and the events; and
generating a summary page including a list of the events and the entities, including a list of the people and a list of the companies, and the related information.

43. The computer program product of claim 42, wherein the method further comprises: obtaining the related information from the content sources includes searching the Internet for Web sites, systems and databases for the related information.

44. The computer program product of claim 42, wherein obtaining a connection path between the user and an entity includes searching a contact database of the user.

45. The computer program product of claim 42, wherein each of the connection paths is defined by information that maps the user to one of the entities mentioned in the content, and which can include a set of intermediate entities not mentioned in the content.

46. The computer program product of claim 42, wherein the method further comprises providing at least some of the primary information and the related information as user selectable links to corresponding detailed information.

47. The computer program product of claim 42, wherein generating the summary page further includes providing targeted advertising related to the primary information, the related information, the user, or a combination thereof.

48. The computer program product of claim 42, wherein the first browser window includes a Web page of a content provider and the graphical mechanism is a toolbar button associated with the content provider and actuation of the toolbar button causes indicia of the content provider and ads related to the content to be presented in the first window, the summary page, or both.
